(19) United States
(12) Patent Application Publication
(10) Pub. No.: US 2002/0075320 A1
(43) Pub. Date: Jun. 20, 2002

(54) Method and apparatus for generating recommendations based on consistency of selection

(75) Inventor: Kaushal Kurapati, Yorktown Heights, NY (US)

Correspondence Address: Corporate Patent Counsel, U.S. Philips Corporation, 580 White Plains Road, Tarrytown, NY, 10591, US

(73) Assignee: Philips Electronics North America Corp.

(21) Appl. No.: 09/736,908

(22) Filed: Dec. 14, 2000

(51) Int. Cl. G06F 15/00

(52) U.S. Cl. 345/811; 345/721

(57) ABSTRACT

A method and apparatus are disclosed for generating recommendations for one or more items based on the consistency with which an item was selected relative to the number of times the item was offered. The present invention adjusts a conventional program recommender score based on a consistency metric. The exemplary consistency metric is defined as the ratio of the number of times an item was selected over the number of times the item was offered in a given time period. In an exemplary program recommendation implementation, the consistency metric is defined as the ratio of the number of times a program was watched over the number of times the program was presented in a given time period. Generated recommendation scores can be increased or decreased in an appropriate manner to reward or penalize a user for consistent or inconsistent, respectively, selection of the item.

### FIELD OF THE INVENTION

The present invention relates to recommendation systems, such as recommenders for television programming or other content, and more particularly, to a method and apparatus for generating recommendations based on the consistency of selections made by a user.

### BACKGROUND OF THE INVENTION

The number of media options available to individuals is increasing at an exponential pace. As the number of channels available to television viewers has increased, along with the diversity of the programming content available on such channels, it has become increasingly challenging for television viewers to identify television programs of interest. Historically, television viewers identified television programs of interest by analyzing printed television program guides. Typically, such printed television program guides contained grids listing the available television programs by time and date, channel and title. As the number of television programs has increased, it has become increasingly difficult to effectively identify desirable television programs using such printed guides.

More recently, television program guides have become available in an electronic format, often referred to as electronic program guides (EPGs). Like printed television program guides, EPGs contain grids listing the available television programs by time and date, channel and title. Some EPGs, however, allow television viewers to sort or search the available television programs in accordance with personalized preferences. In addition, EPGs allow for on-screen presentation of the available television programs.

While EPGs allow viewers to identify desirable programs more efficiently than conventional printed guides, they suffer from a number of limitations, which if overcome, could further enhance the ability of viewers to identify desirable programs. For example, many viewers have a particular preference towards, or bias against, certain categories of programming, such as action-based programs or sports programming. Thus, the viewer preferences can be applied to the EPG to obtain a set of recommended programs that may be of interest to a particular viewer.

Thus, a number of tools have been proposed or suggested for recommending television programming. The Tivo™ system, for example, commercially available from Tivo, Inc., of Sunnyvale, Calif., allows viewers to rate shows using a “Thumbs Up and Thumbs Down” feature and thereby indicate programs that the viewer likes and dislikes, respectively. Thereafter, the TiVo receiver matches the recorded viewer preferences with received program data, such as an EPG, to make recommendations tailored to each viewer.

Such tools for generating television program recommendations provide selections of programs that a viewer might like, based on their prior viewing history. Even with the aid of such program recommenders, however, it is still difficult for a viewer to identify programs of interest from among all the options. Furthermore, currently available program recommenders typically generate a recommendation score based on the user's viewing history. Thus, each time a program is watched, the positive counts associated with the program are incremented, thereafter resulting in a higher program recommendation score for the program. Currently available program recommenders, however, do not consider how frequently the program is watched relative to the number of times the program was offered for viewing.

A need therefore exists for a method and apparatus for recommending content and other items based on the consistency with which the user selected the item each time the item was offered.

### SUMMARY OF THE INVENTION

Generally, a method and apparatus are disclosed for generating recommendations for one or more items based on the consistency with which an item was selected relative to the number of times the item was offered. The present invention adjusts a conventional program recommender score based on a consistency metric.

The exemplary consistency metric is defined as the ratio of the number of times an item was selected over the number of times the item was offered in a given time period. Thus, in a program recommendation implementation, the consistency metric is defined as the ratio of the number of times a program was watched over the number of times the program was presented in a given time period. Thus, generated recommendation scores are increased or decreased in an appropriate manner to reward or penalize a user for consistent or inconsistent, respectively, selection of the item.

A more complete understanding of the present invention, as well as further features and advantages of the present invention, will be obtained by reference to the following detailed description and drawings.

### BRIEF DESCRIPTION OF THE DRAWINGS

FIG. 1 illustrates a television programming recommender in accordance with the present invention;

FIG. 2 is a sample table from the viewer profile database of FIG. 1;

FIG. 3 is a sample table from the program database of FIG. 1; and

FIG. 4 is a flow chart describing an exemplary program recommendation process embodying principles of the present invention.

### DETAILED DESCRIPTION

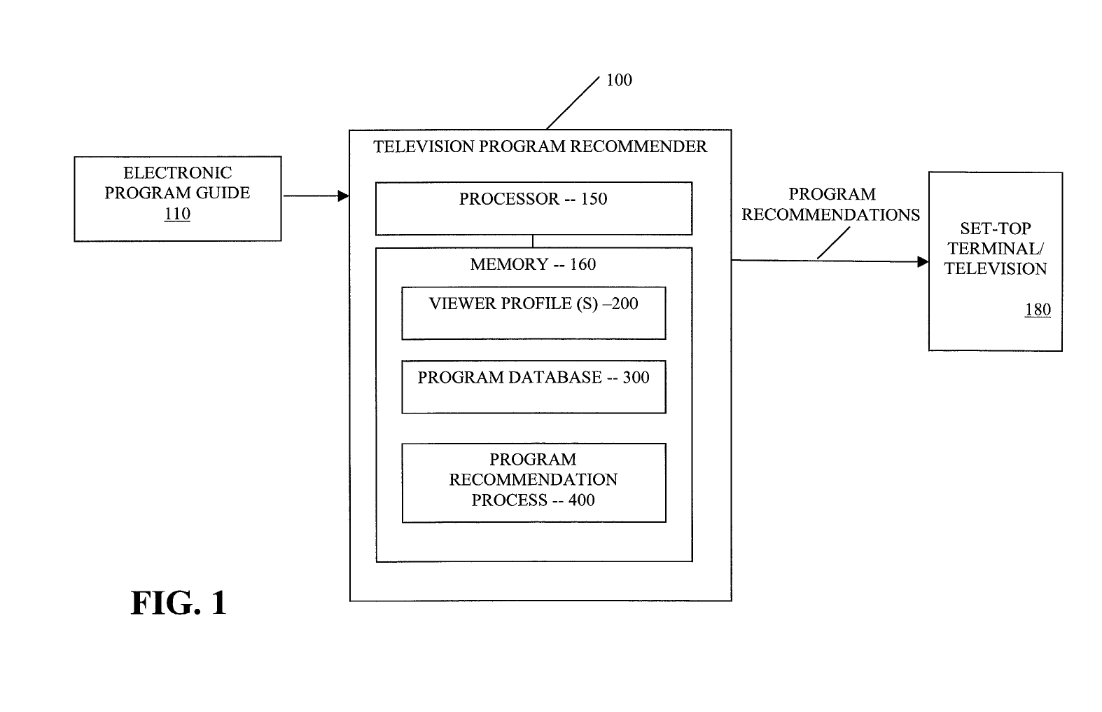

FIG. 1 illustrates a television programming recommender 100 in accordance with the present invention. As shown in FIG. 1, the television programming recommender 100 evaluates each of the programs in an electronic programming guide (EPG) 110 to identify programs of interest to a particular viewer. The set of recommended programs can be presented to the viewer, for example, using a set-top terminal/television 180 using well known on-screen presentation techniques.

According to one feature of the present invention, the television programming recommender 100 generates television program recommendations based on the consistency with which a given item was selected relative to the number of times the item was offered. The present invention adjusts a conventional program recommender score based on a consistency metric. The exemplary consistency metric is defined as the ratio of the number of times an item was selected over the number of times the item was offered in a given time period. The time period can be varied to permit the consistency metric, Cₘ, to focus on recent behavior. The consistency metric may be translated to an adjustment to the conventional program recommender score, for example, using a linear mapping that translates a consistency metric, Cₘ, of 0 to a penalty of 25% and a consistency metric, Cₘ, of 100 to a reward of 25%. Thus, in the illustrative embodiment, the conventional program recommender score can be increased or decreased by up to twenty five percent (25%) to reward or penalize a user for consistent or inconsistent selection of the item, respectively.

While the present invention is illustrated herein in the context of a television program recommender, the present invention can be applied to any automatically generated recommendations that are based on an evaluation of user behavior, such as a viewing history or a purchase history. Thus, in a program recommendation implementation, the consistency metric is defined as the ratio of the number of times a program was watched over the number of times the program was presented in a given time period. For example, if a given program is presented seven times each week and the user watched the program five times in a given week, then the consistency metric, Cₘ, is 5/7.

Likewise, in a more general recommendation implementation, the consistency metric is defined as the ratio of the number of times an item was selected over the number of times the item was offered in a given time period. For example, the item may be books written by a particular author, or a given periodical, such as a magazine.

The television program recommender 100 may be embodied as any computing device, such as a personal computer or workstation, containing a processor 150, such as a central processing unit (CPU), and memory 160, such as RAM and ROM. In addition, the television programming recommender 100 may be embodied as any available television program recommender, such as the Tivo™ system, commercially available from Tivo, Inc., of Sunnyvale, Calif., or the television program recommenders described in U.S. patent application Ser. No. 09/466,406, filed Dec. 17, 1999, entitled “Method and Apparatus for Recommending Television Programming Using Decision Trees,” (Attorney Docket No. 700772) and U.S. patent application Ser. No. 09/498,271, filed Feb. 4, 2000, entitled “Bayesian TV Show Recommender,” (Attorney Docket No. 700690), or any combination thereof, as modified herein to carry out the features and functions of the present invention.

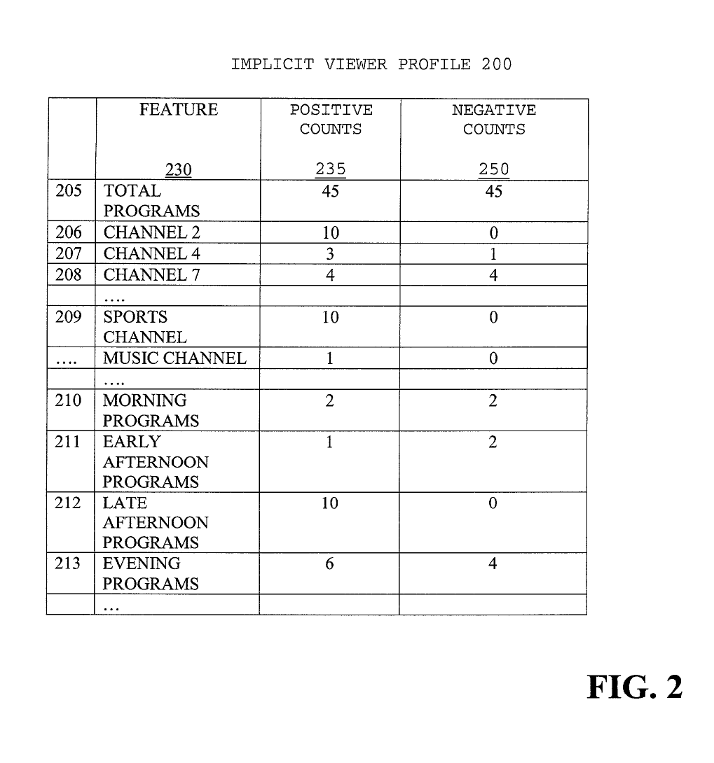

As shown in FIG. 1, and discussed further below in conjunction with FIGS. 2 through 4, respectively, the memory 160 of the television programming recommender 100 includes one or more viewer profile(s) 200, a program database 300 and a program recommendation process 500. Generally, the illustrative viewer profile 200 provides feature counts derived from the user's viewing history. The program database 300 records information for each program that is available in a given time interval. Finally, the program recommendation process 400 generates recommendation scores for each program in a particular time interval, taking into account the consistency with which a given program was selected relative to the number of times the program was presented.

FIG. 2 is a table illustrating an exemplary implicit viewer profile 200. As shown in FIG. 2, the implicit viewer profile 200 contains a plurality of records 205-213 each associated with a different program feature. In addition, for each feature set forth in column 230, the implicit viewer profile 200 provides corresponding positive counts in fields 235 and negative counts in field 250. The positive counts indicate the number of times the viewer watched programs having each feature. The negative counts indicate the number of times the viewer did not watch programs having each feature.

For each positive and negative program example (i.e., programs watched and not watched), a number of program features are classified in the user profile 200. For example, if a given viewer watched a given sports program ten times on Channel 2 in the late afternoon, then the positive counts associated with these features in the implicit viewer profile 200 would be incremented by 10 in field 235, and the negative counts would be 0 (zero). Since the implicit viewing profile 200 is based on the user's viewing history, the data contained in the profile 200 is revised over time, as the viewing history grows. Alternatively, the implicit viewer profile 200 can be based on a generic or predefined profile, for example, selected for the user based on his or her demographics.

Although the viewer profile 200 is illustrated using an implicit viewer profile, the viewer profile 200 may also be embodied using an explicit profile, or a combination of explicit and implicit profiles, as would be apparent to a person of ordinary skill in the art. For a discussion of a television program recommender 100 that employs both implicit and explicit profiles to obtain a combined program recommendation score, see, for example, U.S. patent application Ser. No. 09/666,401, filed Sep. 20, 2000, entitled “Method And Apparatus For Generating Recommendation Scores Using Implicit And Explicit Viewing Preferences,” (Attorney Docket Number 701247), incorporated by reference herein.

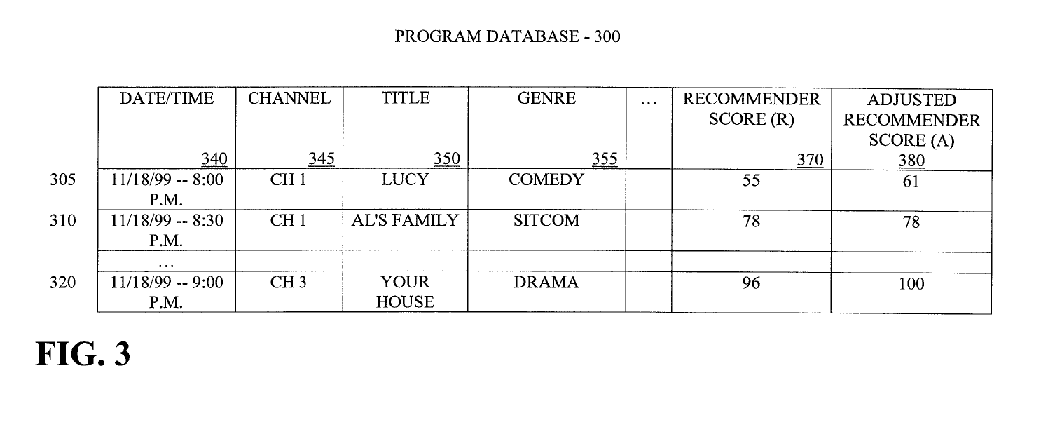

FIG. 3 is a sample table from the program database 300 of FIG. 1 that records information for each program that is available in a given time interval. The data that appears in the program database 300 may be obtained, for example, from the electronic program guide 110. As shown in FIG. 3, the program database 300 contains a plurality of records, such as records 305 through 320, each associated with a given program. For each program, the program database 300 indicates the date/time and channel associated with the program in fields 340 and 345, respectively. In addition, the title and genre for each program are identified in fields 350 and 355. Additional well-known attributes (not shown), such as actors, duration, and description of the program, can also be included in the program database 300.

The program database 300 may also optionally record an indication of the recommendation score (R) assigned to each program by the television programming recommender 100 in field 370. In addition, the program database 300 may also optionally indicate in field 370 the adjusted recommendation score (A) assigned to each program by the television programming recommender 100 in accordance with the present invention. In this manner, the numerical scores, as adjusted by the present invention, can be displayed to the user in the electronic program guide with each program directly or mapped onto a color spectrum or another visual cue that permits the user to quickly locate programs of interest.

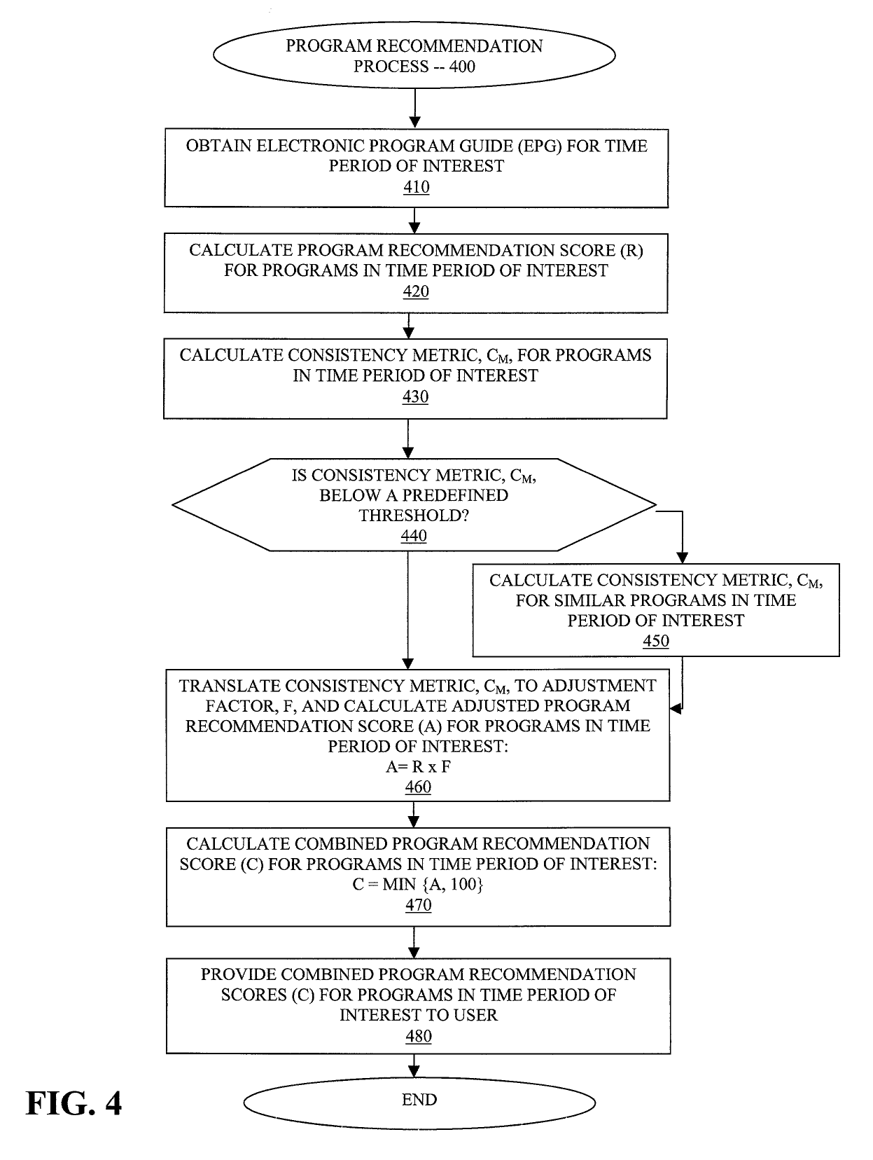

FIG. 4 is a flow chart describing an exemplary program recommendation process 400 embodying principles of the present invention. As shown in FIG. 4, the program recommendation process 400 initially obtains the electronic program guide (EPG) 110 during step 410. Thereafter, the program recommendation process 400 calculates the program recommendation score, R, during step 420 for each program in the time period of interest in a conventional manner (or obtains the program recommendation score, R, from a conventional recommender).

Thereafter, the program recommendation process 400 calculates the consistency metric, C_{M}, for each program in the time period of interest during step 430. A test is then optionally performed during step 440 to determine if the calculated consistency metric, Cₘ, is below a predefined threshold. Generally, the test performed during step 440 is intended to prevent a user from being penalized if the viewer failed to watch a program at all, or only watched the program a nominal amount of times.

If it is determined during step 440 that the calculated consistency metric, Cₘ, is below a predefined threshold, then the consistency metric, Cₘ, is calculated during step 450 for similar programs that may be relevant to the consistency of the current program. Generally, similar program may be identified, for example, by evaluating a closeness metric that compares the various program features of two programs. The similarity can be computed, for example, as a dot product of two feature vectors corresponding to the television programs. Generally, if S1 and S2 are the two shows, the shows can be characterized as: S1 (Program 101): <genre: comedy, genre: situation, genre: family, channel: NCB>and S2 (Program 228): <genre: comedy, genre: situation, genre: family, channel: NCB>. The dot product of S1 and S2 would be a weighted, normalized average. A weight can be assigned for the similarity of each feature, such as genre and channel similarities. In addition, certain features, such as day-time may be optionally considered in the computation because if the shows are on the same channel, two programs will never be on the same channel at the same time. Using the day-time feature makes sense only in the case of different channels. The weights should add up to 1.0.

If, however, it is determined during step 440 that the calculated consistency metric, Cₘ, is not below a predefined threshold, then the calculated consistency metrics, Cₘ, for each program in the time period of interest (or for similar programs if the consistency metric, Cₘ, was below a threshold) are translated during step 460 to an adjustment factor, F, for example, using a linear mapping, and then the adjusted program recommendation score, A, is also calculated during step 460 for each program in the time period of interest, as follows:

A=R·F.

The program recommendation process 400 then calculates the combined program recommendation score, C, during step 470 for each program in the time period of interest, as follows:

C=MIN{A,100}

Thus, the exemplary program recommendation process 400 ensures during step 470 that the combined program recommendation score, C, does not exceed 100% (the maximum score).

Finally, the program recommendation process 400 provides the combined program recommendation scores (C) for the programs in the time period of interest to the user during step 450, before program control terminates.

In further variations of the program recommendation process 400, the adjusted program recommendation score, A, may be calculated during step 430 using a bonus scoring system, wherein a predefined or fixed bonus is determined, for example, based on the consistency metric.

It is to be understood that the embodiments and variations shown and described herein are merely illustrative of the principles of this invention and that various modifications may be implemented by those skilled in the art without departing from the scope and spirit of the invention.

What is claimed is:

1. A method for recommending items, comprising the steps of:
obtaining a list of one or more available items;
obtaining a recommendation score, R, for said one or more available items;
calculating an adjustment, A, to said recommendation score, R, based on a consistency with which an item was selected by a user relative to the number of times the item was offered; and
generating a combined recommendation score, C, based on said recommendation score, R, and said adjustment, A.

2. The method of claim 1, wherein said list of one or more items are programs obtained from an electronic program guide.

3. The method of claim 1, wherein said recommendation score, R, is provided by an explicit program recommender.

4. The method of claim 1, wherein said recommendation score, R, is provided by an implicit program recommender.

5. The method of claim 1, wherein said recommendation score, R, is defined as a weighted average of individual ratings of program features.

6. The method of claim 1, further comprising the step of presenting said combined recommendation score, C, for each of said one or more programs to a user.

7. The method of claim 1, wherein said adjustment to said recommendation score, R, does not exceed a predefined value.

8. A method for recommending items, comprising the steps of:
obtaining a list of one or more available items; and
calculating a recommendation score for said one or more items based on a consistency with which an item was selected by a user relative to the number of times the item was offered.

9. The method of claim 8, further comprising the step of presenting said combined recommendation score, C, for said program to a user.

10. The method of claim 8, wherein said list of one or more available items are programs obtained from an electronic program guide.

11. A system for recommending items, comprising:
a memory for storing computer readable code; and
a processor operatively coupled to said memory, said processor configured to:
obtain a list of one or more available items;
obtain a recommendation score, R, for said one or more available items;
calculate an adjustment, A, to said recommendation score, R, based on a consistency with which an item was selected by a user relative to the number of times the item was offered; and
generate a combined recommendation score, C, based on said recommendation score, R, and said adjustment, A.

12. The system of claim 11, wherein said list of one or more items are programs obtained from an electronic program guide.

13. The system of claim 11, wherein said recommendation score, R, is provided by an explicit program recommender.

14. The system of claim 11, wherein said recommendation score, R, is provided by an implicit program recommender.

15. The system of claim 11, wherein said recommendation score, R, is defined as a weighted average of individual ratings of program features.

16. The system of claim 11, wherein said processor is further configured to present said combined recommendation score, C, for each of said one or more programs to a user.

17. The system of claim 11, wherein said adjustment to said recommendation score, R, does not exceed a predefined value.

18. A system for recommending items, comprising:
a memory for storing computer readable code; and
a processor operatively coupled to said memory, said processor configured to:
obtain a list of one or more available items; and
calculate a recommendation score for said one or more items based on a consistency with which an item was selected by a user relative to the number of times the item was offered.

19. The system of claim 18, wherein said processor is further configured to present said combined recommendation score, C, for said program to a user.

20. The system of claim 18, wherein said list of one or more available items are programs obtained from an electronic program guide.

21. An article of manufacture for recommending television items, comprising:
a computer readable medium having computer readable code means embodied thereon, said computer readable program code means comprising:
a step to obtain a list of one or more available items;
a step to obtain a recommendation score, R, for said one or more available items;
a step to calculate an adjustment, A, to said recommendation score, R, based on a consistency with which an item was selected by a user relative to the number of times the item was offered; and
a step to generate a combined recommendation score, C, based on said recommendation score, R, and said adjustment, A.

22. An article of manufacture for generating a recommendation score for an item, comprising:
a computer readable medium having computer readable code means embodied thereon, said computer readable program code means comprising:
a step to obtain a list of one or more available items; and
a step to calculate a recommendation score for said one or more items based on a consistency with which an item was selected by a user relative to the number of times the item was offered.
